(19) United States
(12) Patent Application Publication
(10) Pub. No.: US 2016/0070866 A1
(43) Pub. Date: Mar. 10, 2016

(54) Personal Health Card - A card and software application to maintain personal health information

(71) Applicant: Shanthakumari Raju, Phoenix, AZ (US)

(72) Inventor: Shanthakumari Raju, Phoenix, AZ (US)

(73) Assignee: Ravi Kumar Govindan, Phoenix, AZ (US)

(21) Appl. No.: 14/481,301

(22) Filed: Sep. 9, 2014

(51) Int. Cl. G06F 19/00

(52) U.S. Cl. CPC G06F 19/323

(57) ABSTRACT

‘Personal Health Card’ is a magnetic strip/chip card, which could be carried in a purse/bag/pocket/wallet all the time, this will help the User to get the right kind of treatment during emergencies, when the User is unable to respond or during normal visit to any doctor's office. This Health Card when scanned/read using a Card Reader by a First Responders/Hospital Front desk/Health Care providers, would give information about the Registered User's First Name, Last Name, DOB, Address, Emergency contact, allergies, recent health history/symptoms, prescription medications or over-the-counter medication that they are on, which was self-maintained by the Registered User. The information is as latest as the Registered User's last update. This could help the doctors to get more information about the Registered User, and would know what medications they are currently on, so that they are aware of their Registered User's pre-existing health conditions, if any and treat them appropriately.

### SPECIFICATION

‘Personal Health Card’ is a magnetic strip/chip card that could be carried in a purse/wallet/bag/pocket etc. all the time, so that in case of health emergencies or to a doctor's office visit, this could help to get the right medical treatment.

A wed/client server based Personal Health Care Software application would be developed, where interested Registered Users could register and get a magnetic strip/chip card by mail.

Once the magnetic strip/chip is received by the Registered User, it could be activated by phone/mail/logging in and the Registered User can go ahead and update their information in the appropriate pages and fields.

The Registered User's information would be updated in both the site and on the magnetic strip/chip card immediately, as the Registered User updates and saves their information. The Registered User logs in to their account using a desktop, portable devices (mobile/tablet etc) and maintains their account current in order to receive the right medical treatment in case of emergencies or during a visit to doctor's office.

The Hospitals/First responders/Paramedics could have a Card reader/Scanner to read/scan the ‘Personal Health Card’ when responding to emergencies. By scanning/reading the card they could have some information about the Registered User like Profile information, emergency contact information, the latest health symptoms if they have experienced and documented, currently if they are on any medications, any allergies etc.

The software application has two separate logins, First one is for the Registered Users to login and update their health conditions and details and the Second Login is for the authorized Hospitals/Health Care Providers/First Responders etc. where they have to use an assigned unique code and password to access the Registered User's medical information.

If the account is accessed by someone other than the Registered User, say for an example an authorized Hospitals/Health Care Providers/First Responders etc. it would keep an account of the details of who/organization/hospital that had accessed it to the Registered User's Records, and the Registered User can keep track of that.

If a Hospital/Health Care Provider are not registered then they get to generate a unique key by give their information to access the Registered User's information.

When an authorized Hospitals/Health Care Providers/First Responders etc get the access to the Registered User's information, it lets them know when it was updated last, so that it could give some more information about the Registered User's health condition.

It is encouraged that both the hospitals and Patient's to get registered, so that the Registered Users get to maintain their medical records and the Hospitals could serve their Registered Users better.

### DIAGRAMS

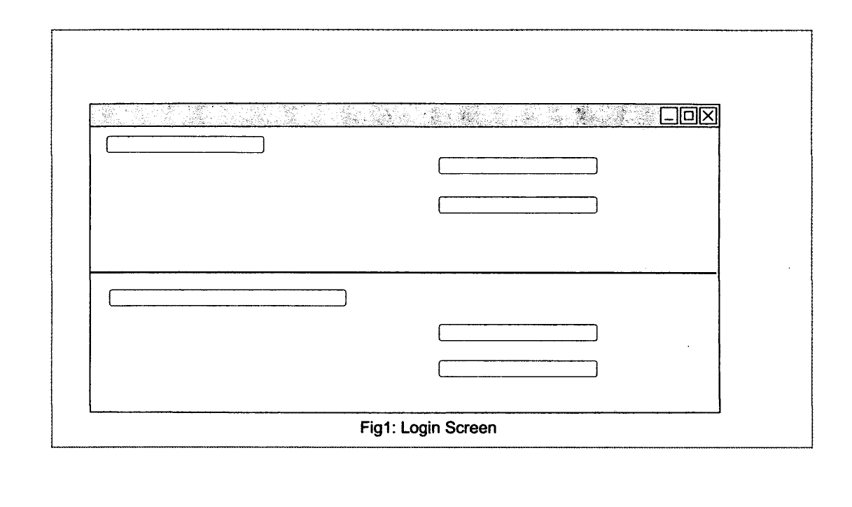

1. FIG. 1: FIG. 1_Login Screen.PDF shows the draft Login Page experience

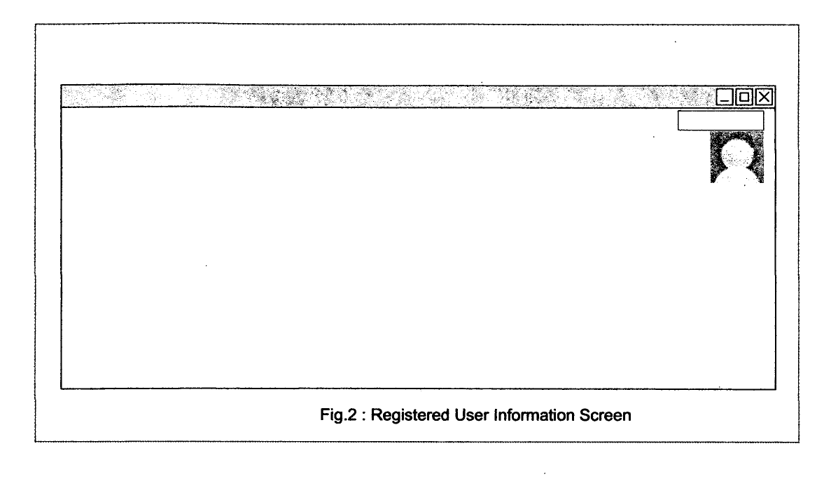

2. FIG. 2: FIG. 2_Registered User Information Screen.PDF shows the draft Registered User/Registered Users Information management Page

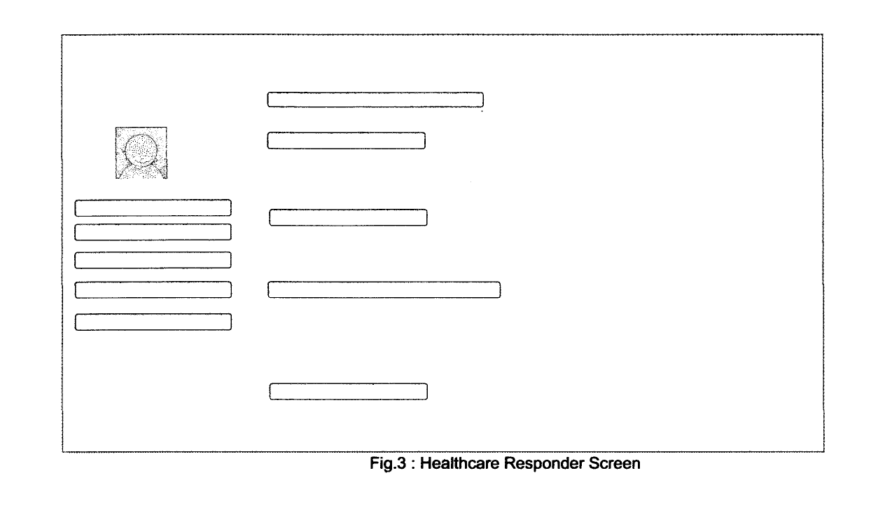

3. FIG. 3: FIG. 3 Healthcare Responder Screen.PDF shows the draft Page and experience for Healthcare Professionals/First Responders experience.

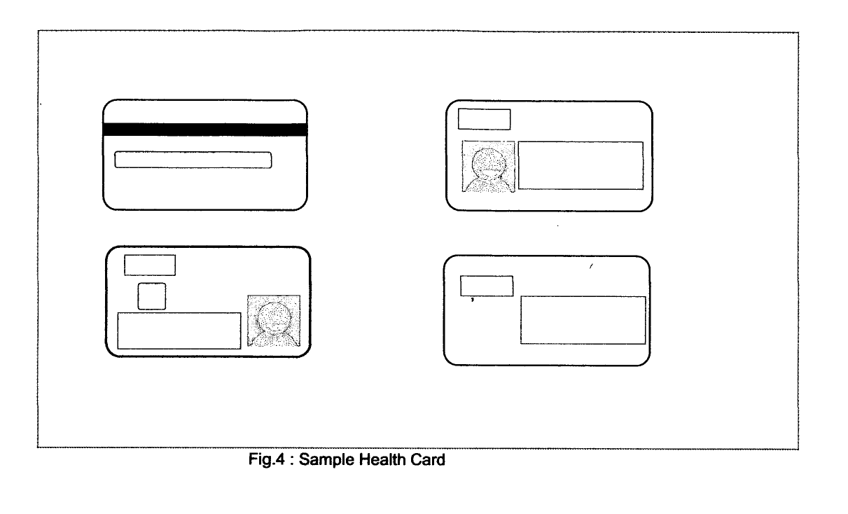

4. FIG. 4: Sample Health Card

1. A Software application to maintain/manage a Registered User's pre-existing health condition, medications that they are on, all allergies that they have, health symptoms that they are experiencing, any treatment that the Registered User is undergoing, emergency contact information, over-the-counter medications that they would take for common health problems etc.

2. The claim for 1 is that, a Registered User would have a magnetic strip/chip card, which when scanned or used with a Card Reader by a Hospital staff, Clinic or authorized Health Care Professionals (First responders/Fire Fighters/Paramedics etc.) would give the details about the Registered User's medical background, so that they could be given the right treatment.

3. The claim for 1 and 2 is that, this is achieved by a working Software Application specifically with a magnetic strip/chip card and a card reader/scanner.

4. The claim is that, the Registered User for this application would receive a magnetic strip/chip card by mail with their name embossed, expiration date etc. At this point it is not decided whether the magnetic card would have an expiration date, or if any other details might be required on that Card apart from the company logo etc.

5. The claim is that, the Registered User after registering and receiving a magnetic strip/chip card can activate the card via phone call or logging in after which they could use the application to update their medical history, existing condition, any new health symptoms that they are currently experiencing, medications that they are currently on, over-the-counter medications frequently taken, any habits like smoking/alcohol, allergies, emergency contact person and their info etc. Apart from this the Registered User gives the permission for any health care provider, emergency responders etc. the authorization to Use the Card to swipe through the Card Reader/Scanner during emergencies, by selecting the necessary terms and conditions on the software application.

6. The claim is that, if the Registered User does not want to give the permission to access all the information on their profile, can customize it according to their wish. But, in order to be served better, the Registered Users are encouraged to give their medical history, any health symptoms that they had experienced lately, any medications that they are on, emergency contact information etc.

7. The claim is that, only intended Registered User can log in using their Registered User Id, Password and get access to the software application and maintain their health information. In case of emergencies, where the Registered User is in a situation that they cannot respond physically due to some medical condition, then authorized Health Care Professionals, first responders can scan the magnetic strip/chip card or use it with the card reader and get the information about the Registered User and would get to know what medications they are currently on, what new symptoms that they are experiencing. The Healthcare Professionals, Hospitals can register with this web application and receive a unique key number, password with which they access the Registered User's information.

8. The claim is that, once the magnetic card has been scanned/run on a card reader by any Health Care Professional, First responders etc. and have accessed the Registered User's information, it would be recorded on the Registered User's account that who had accessed the information, when it was scanned etc. By this Registered User knows that the personal medical information has been viewed by an authorized person only. If the HealthCare Professional, first responders have not received a unique key number, then a unique random number would be generated where they have to give other information about their Hospital etc. and get the access to the Registered User's information.

9. The claim is that, hospitals/health care providers/first responders would have a working card scanner/reader in order to scan the ‘Health Card’.

10. The claim is that, a Registered User needs an access to a desktop, mobile device to update their information.

11. The claim is that, QR Scan could also be used to scan a Registered User's information, other than regular magnetic strip/chip card with scanner/reader where it is applicable.

12. The claim is that, when the magnetic strip/chip card is scanned, it gives a profile picture of the Registered User or according to the Country in which this application would be used, will have the driver's license details with/without picture id, so that the healthcare professionals, first responders know if that Magnetic Card belongs to the Registered User or not by comparing the picture with the face.

13. The claim is that, when a Registered User scans their medication/prescription barcode, QR Scan code it could automatically update their medications details.

14. The claim is that, if every time when it is logged in by the Registered User or if the magnetic card is scanned using the Card Reader it would give the date when it was last used, so that in case of emergencies the paramedics, healthcare professionals would know when it was last used and the details related to the last usage.

15. The diagrams/wireframe submitted with these claims are a draft ones, the application when developed might change and would be updated with USPTO.

16. FIG. 1_Login Screen.PDF shows the draft Login Page experience.

17. FIG. 2_Registered User Information Screen.PDF shows the draft Registered User/Registered Users Information management Page.

18. FIG. 3 Healthcare Responder Screen.PDF shows the draft Page and experience for Healthcare Professionals/First Responders experience.

19. FIG. 4 Sample of ‘Personal Health Card’, not accurate as it could be modified.
